(19) United States
(12) Patent Application Publication
(10) Pub. No.: US 2008/0164310 A1
(43) Pub. Date: Jul. 10, 2008

(54) Labeling system

(76) Inventors: Charles G. Dupuy, Corvallis, OR (US); Alan R. Arthur, Corvallis, OR (US); Kurt Cleveland, Corvallis, OR (US); Gregory J. May, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/651,384

(22) Filed: Jan. 9, 2007

(51) Int. Cl. G06F 19/00

(52) U.S. Cl. 235/385

(57) ABSTRACT

A labeling system includes at least one display device associated with one or more particular locations within a space and a device associated with the at least one display device that identifies that display device or a portion thereof with a particular location in the space.

### BACKGROUND

In the retail industry considerable time, effort, and financial resources are dedicated to maintaining inventory. When a change is to be made to the inventory layout, the process of removing the existing inventory, rearranging shelving, redistributing shelf-edge labels, and restocking the shelves can be tedious, time consuming and prone to errors in placement and/or content of the labels.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 illustrates an exemplary embodiment of electronic labeling system, according to principles described herein.

FIG. 2 illustrates a front view of an exemplary graphical display device, according to one exemplary embodiment of principles described herein.

FIGS. 3a and 3b illustrate views of exemplary shelf edges, according to one exemplary embodiment of principles described herein.

FIGS. 4a and 4b illustrate an embodiment in which each physical location within the storage space is configured to communicate an identifier of that location to a graphical display device when that display device is installed at that location.

FIG. 5 illustrates a front view of an exemplary graphical display device, according to one exemplary embodiment of principles described herein.

FIGS. 6a and 6b illustrate a front view of an exemplary graphical display device in different operating modes, according to one exemplary embodiment of principles described herein.

FIG. 7 illustrates a front view of an exemplary graphical display device and encoder strip, according to one exemplary embodiment of principles described herein.

FIGS. 8a and 8b illustrate an exemplary store floor and its layout, according to one exemplary embodiment of principles described herein.

FIG. 8c is a flowchart illustrating an exemplary method of creating a map of graphical display device addresses within a physical storage space, according to one exemplary embodiment of principles described herein.

FIG. 9 illustrates a front view of an exemplary graphical display device, according to one exemplary embodiment of principles described herein.

FIG. 10 illustrates an exemplary auditing process, according to one exemplary embodiment of principles described herein.

FIG. 11 is a flow chart of an exemplary inventory layout setup, according to one exemplary embodiment of principles described herein.

The same reference number used in different figures refers to similar, but possibly not identical, elements.

### DETAILED DESCRIPTION

The present exemplary systems and methods provide for the implementation and operation of an inventory locator system in connection with an electronic labeling system. In particular, according to one exemplary embodiment, an electronic labeling system can be configured to upload an inventory layout and implement this layout via graphical display devices dispersed throughout a storage or retail space for correct placement and identification of inventory items. In some embodiments, the dispersed graphical display devices can automatically identify their position within the space to a central computing system. These exemplary embodiments can assist staff and customers in locating a particular item in the inventory.

As used in the present specification and in the appended claims, the term Electronic Labeling System (“ELS”) is meant to be understood broadly as including any system that provides labeling for a specific shelf space or inventory location using at least one form of graphical display device that is communicatively coupled to at least one central computing system. An ELS may or may not also include a handheld transmitting device in communication with the central computing system.

The term “graphical” as in “graphical display device” is meant to be understood as referring to any visual element. Thus, the graphical display device or devices can display any visual element or combination of visual elements including, but not limited to, text, numbers (e.g., prices), colors, images, graphs, logos, barcodes, arrows, symbols, etc. The term “display device” will also be understood to mean a device with this capability of displaying any visual element or combination of visual elements.

As used in the present specification and in the appended claims, the terms “storage space” or “storage facility” are intended to refer broadly to any location or facility in which an inventory of goods is stored. Consequently, the term “storage space” includes, but is not limited to, a retail store sales floor, a wholesale or other vendor facility, a stockroom, a warehouse, a backroom where inventory is stored away from a sales floor, etc.

In the following description, for purposes of explanation, numerous specific details are set forth in order to provide a thorough understanding of the present systems and methods for forming an inventory locator system in connection with an electronic labeling system. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are possibly not all referring to the same embodiment.

For many retailers, a large component of inventory maintenance is the creating and setting up of inventory layouts. Inventory layouts map the arrangement and location of inventory, i.e., products or goods, on the available shelf space of the retailer. In many cases, inventory layouts are distributed by a corporate office to their associated retail branches, where the inventory layout is then implemented by the staff.

Each product typically has-a corresponding shelf-edge label to indicate information to a customer or employee such as the price and intended location of a certain product. Typically, inexpensive pieces of cardstock, paper, and/or plastic are used for shelf-edge labels. Using the inventory layout and a set of shelf-edge labels, retailers are able to create an organized and visually professional display of inventory placement. Unfortunately, when a change needs to be made to the inventory layout, the process of removing the existing inventory, rearranging shelving, redistributing shelf-edge labels, and restocking the shelves can be tedious and time consuming. Additionally, given the human capacity for error, labels may be incorrectly printed or placed or may be outdated and show incorrect prices. This can cause significant friction between a retailer and the customer when the expected price as indicated by the self-edge label does not agree with the price charged at the register.

One way of alleviating such issues has been the development of electronic labeling systems (ELSs). Electronic labeling systems overcome most pricing inaccuracies by using graphical display devices as the shelf-edge labels. These graphical display devices may be updated by a central computing system to reflect current pricing or information about a product. An ELS is generally comprised of at least one graphical display device that has a graphical display, such as a liquid crystal display (LCD) device, to display the price and/or other product information. A series of these graphical display devices can be placed along the edge of a shelf or otherwise associated with particular a shelf space.

This graphical display device is then communicatively coupled with a central computing system, which is responsible for maintaining inventory data in addition to current and correct prices. Thus, instead of using plastic or cardstock labels, which must be replaced or physically modified for any change in inventory layout, a retailer can have an electronic means of maintaining and displaying correct prices.

However, although an ELS may overcome customer issues caused by inconsistent pricing, the use of existing electronic labeling systems still does not generally overcome the challenges of setting up inventory layouts, or locating the proper self position for products being placed into inventory.

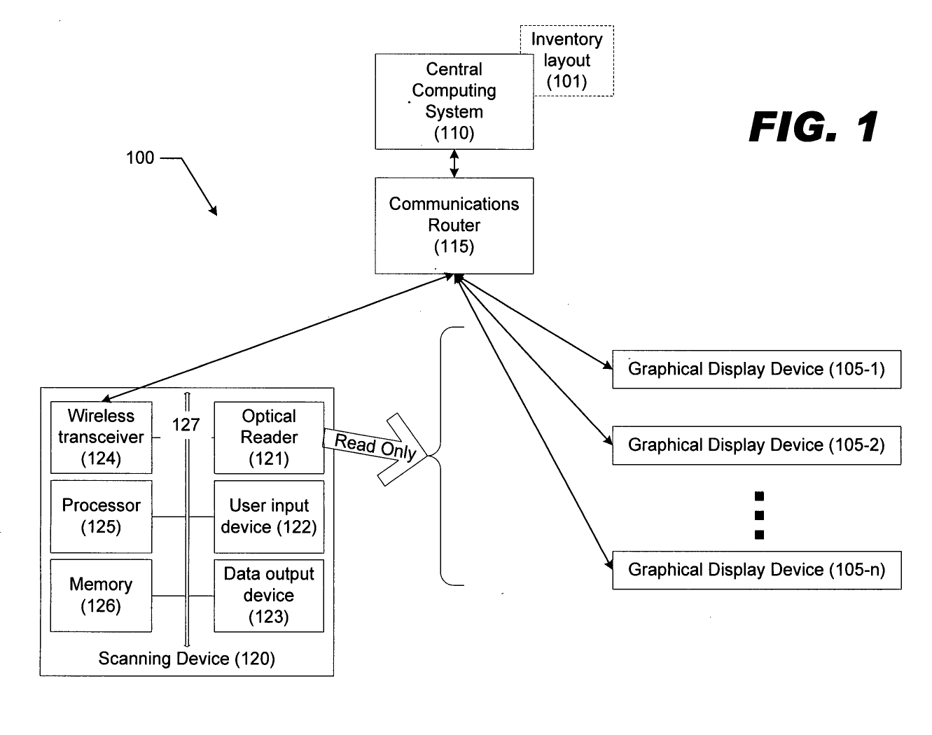

FIG. 1 illustrates an exemplary electronic labeling system (100) according to one exemplary embodiment. As shown in FIG. 1, the ELS (100) includes a number of graphical display devices (105-1 through 105-n) that are used to dynamically present labeling for shelf space or a storage location within an inventory in a storage space. Each graphical display device (105) can be driven using electronic data, as will be described below, to display desired text, pricing, images, symbols or other visual information.

Each graphical display device (105) is communicatively coupled to a central computing system (110). The communication between the graphical display devices (105) and the central computing system (110) can be wired or wireless as will be described in further detail below. The central computing system (110) can accordingly control the information displayed on each of the graphical display devices (105). The general components of the central computing system (110) may include, for example, a central processing unit (CPU), a memory unit, and an input/output interface.

A communications router (115) routes data signals from the central computing system (110) to corresponding graphical display devices (105). The central computer system (110) can individually address and control any of the graphical display devices (105) as described herein. The communications router (115) may also receive signals from the various graphical display devices (105) for transfer to the central computing system (110).

The central computing system (110) can be a computer that is designed for and/or dedicated to the ELS (100). Alternatively, the central computing system (110) may be a general purpose computer that is tasked with supporting the ELS functions as its sole function or in addition to other tasks or functions. As indicated above, changes and updates to graphics and images displayed on the graphical display devices (105) are controlled by the central computing system (110). The central computing system (110) is also responsible for storing information, such as an inventory layout (101), that is used in the function of the ELS (100) and for filling requests made by various components of the ELS (100) as described below. The inventory layout (101) includes a map of the storage space including each unit of shelf space in the storage space and the product or products that are to be stored on that unit of shelf space.

A scanning device (120) may also be used as part of the ELS (100). As shown in FIG. 1, the scanning device (120) incorporates an optical reader (121), such as a bar code scanner; and a user input device (122), such as an alphanumeric or numeric keypad, a keyboard, a touch-sensitive screen or the like. In some embodiments, the scanning device (120) also includes a data output device (123), such as a display device or screen, for example, a liquid crystal display (LCD) device or other display device for displaying data to a user.

The optical reader (121) of the scanning device (120) may be, but is not limited to, an infrared scanner, laser scanner, light emitting diode scanner (LED), digital camera or the like. The optical reader (121) is configured to scan a machine-readable representation of information in a visual format, e.g., a barcode. These barcodes and similar visual displays of machine-readable data may be printed or may be displayed on the graphical display devices (105) and may encode, for example, information about a particular product in inventory, an identifier of a particular segment of a graphical display device (105), or an identifier of a particular location within a storage space. A Universal Product Code (UPC) is an example of a barcode that might be displayed on the graphical display devices (105).

In the present embodiment, the handheld scanning device (120) has a “read only” relationship with the graphical display devices (105). That is, the scanning device (120) can read data from a graphical display device (105) using the optical reader (121), but does not directly communicate a change or update to a graphical display device (105). However, the scanning device (120) may both send information to and receive information from the central computing system (110) using a wireless transceiver (124). Consequently, to effect any changes to images displayed by the graphical display devices (105), the scanning device (120) can communicate with the central computing system (110), which will then execute the change as described above. However, in other embodiments, the scanning device (120) may communicate directly with the graphical display devices (105) or other components of the system, or may act as a repeater.

A user may operate the user input device (122) of the scanning device (120) to generate instructions to change or update a display on a graphical display device (105) and transmit those instructions to the central computing system (110). For example, if there is a local in-house sale authorized by a store manager, the scanning device (120) could be used to identify the product at issue to the central computing system (110) and initiate an update of the price being displayed on a particular graphical display device (105) associated with the location of that product in the storage space. For example, a worker in the storage space uses the scanning device (120) to scan a UPC identifying the product for which the sale price is to be implemented. The worker then inputs the updated price and transmits the data to the central computing system (110) using the transceiver (124). The central computing system (110) then drives the corresponding graphical display device (105-n) to update the price displayed for the identified product. This is merely one example of a use of the scanning device (120). The scanning device (120) has a wide variety of uses in the system (100). Various other uses of the scanning device (120) will be described below.

An onboard processing unit (125) with access to a memory unit (126) for storing firmware controls the operation of the scanning device (120). A data bus (127) is used to interconnect and provide communication among the various components of the scanning device (120).

The scanning device (120) can be a portable, handheld unit that is used primarily by staff or employees in the storage space containing the ELS (100). Additionally, the scanning device (120) can be a stationary unit that is installed in the storage space for use primarily by customers. In other embodiments, the scanning device (120) may be installed in, for example, a shopping cart, forklift, or other device for moving products or people within the storage space.

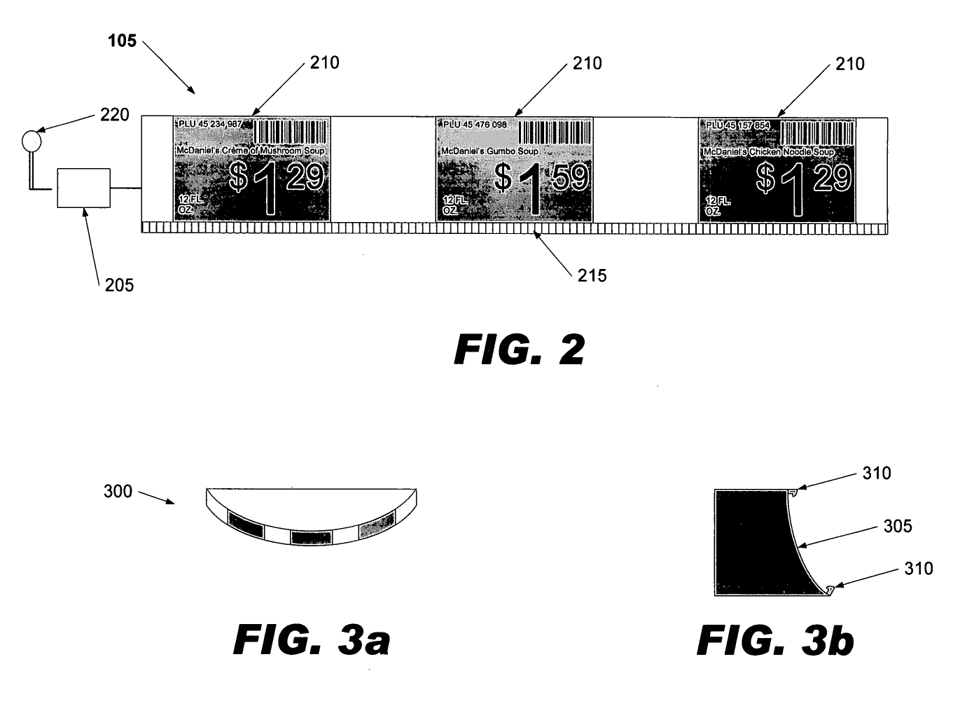

FIG. 2 illustrates an exemplary graphical display device (105), according to one exemplary embodiment. As shown in FIG. 2, the graphical display device (105) interfaces with a person through the display of images, text, numeric data, symbols, and the like. An exemplary graphic displayed on the graphical display device (105) includes one or a series of product labels (210) as shown in FIG. 2.

In some embodiments, each graphical display device (105) is further configured with an encoder strip (215) that identifies the corresponding graphical display device (105) or portion of a graphical display device (105) with which it is associated. The uses of this encoder strip (215) will be described in more detail below.

The graphical display device (105) may be formed as a strip that extends the length of the shelf. Alternatively, in some embodiments, the graphical display device (105) is fabricated to extend along a segment of a shelf length. By extending the length of the shelf, the graphical display device (105) may display multiple product labels (210), in a continuously configurable fashion, on one display device (105) as shown in FIG. 2, removing the motivation to have multiple graphical display devices (105) along a single shelf. The graphical display device (105) can be fabricated to fit a wide range of lengths and widths as best suits a particular application.

In some embodiments, the graphical display device (105) is a plastic-based display device for use on the shelving of the storage space. However, the graphical display device (105) may be fabricated from many different materials, including not limited to, plastics, glasses, metals, alloys, ceramics, and the like. Consequently, some embodiments of the graphical display device (105) may be flexible, while others are more rigid due to the materials used to construct that graphical display device (105).

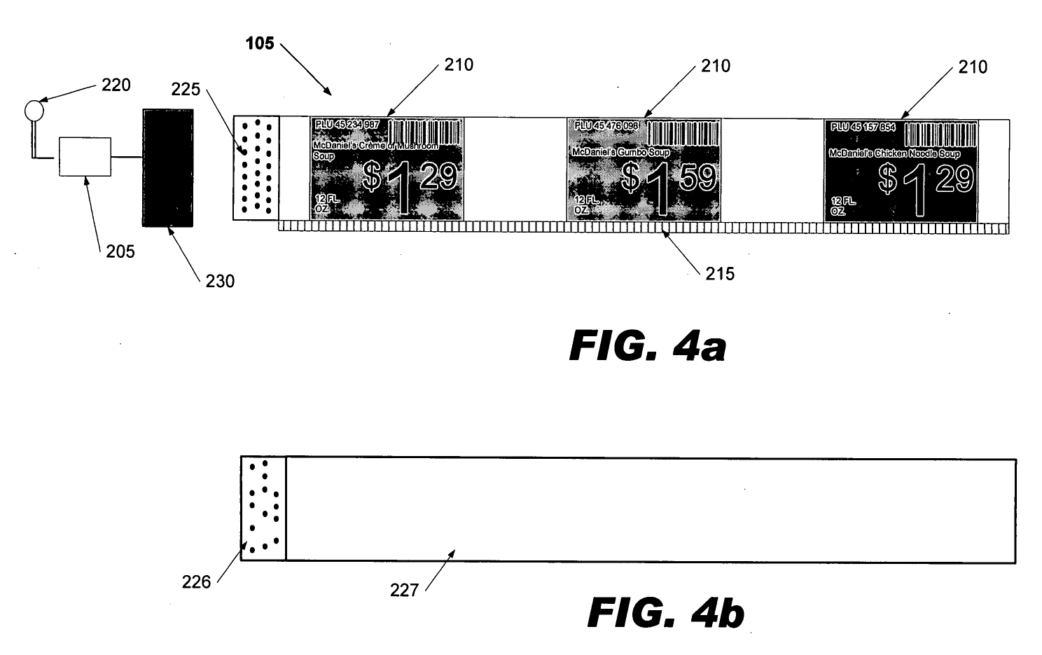

One advantage of using a flexible graphical display device (105) is that the display device (105) can curve along its length, for example, to conform to curved shelves (300, FIG. 3a). A flexible graphical display device (105) may also curve along its width. This is useful in applications where the shelves on which graphical display device (105) is used have a curved channel along the front of the shelf edge. This configuration is common in storage space shelving and is called a C-channel (305, FIG. 3b.). This C-channel (305) is generally concave and has a pair of grooves (310) that run along the top and bottom edges of the C-channel (305). Therefore, a flexible graphical display device (105) would conform to the shape of the C-channel (305) and fit snugly between the grooves (310).

The display of the graphical display device (105) can be reflective, transmissive or transflective using any number of possible electronic display technologies, such as a liquid-crystal display (LCD), electronic paper, etc. The terms reflective, transmissive or transflective refer to the way in which a display is lit. A transmissive display has a backlight that directs light through the display device toward a viewer. A reflective display is not backlit, but reflects ambient light so as to be visible to a viewer.

Electronic paper is a bi-stable display, which uses power when changing or setting an image and does not use power when it is not changing or setting an image. This reduces power consumption. A simplified example of electronic paper has a liquid polymer layer sandwiched between two arrays of electrodes. Embedded in the polymer layer is a multitude of polarized pigment capsules having positively and negatively charged poles. Each pole of the capsule has an associated color, e.g. the positive pole is white and the negative pole is black. When an electric field is applied through the electrode array, the capsules align themselves with the field showing either a white side or a pigmented side. This polarizing characteristic of electronic paper allows images to be displayed on the surface, while consuming very low amounts of power. As indicated above, the present exemplary graphical display device (105) could use such a technology to display desired merchandise information in a power efficient format.

An electronic controller (205) such as an integrated circuit may be used to control the graphics displayed on the graphical display device (105) under the direction of the central computing system (110, FIG. 1). The controller (205) may also control communication with the central computing system (110, FIG. 1) and power consumption of the graphical display device (105). As indicated above, the electronic controller (205) may communicate with the central computing system (110, FIG. 1) through either a wired or wireless data channel. In the example of FIG. 2, a wireless transceiver (220) provides communication between the controller (205) and the central computing system (110, FIG. 1).

The electronic controller (205) which updates and powers the graphical display device (105) could be placed at one end of the label, as depicted in FIG. 2. The controller (205) may, in some examples, be incorporated into the display strip (105). Alternatively, the controller (205) may be communicatively coupled to the end of the graphical display device (105) strip with a connection device such as a data cable. In such examples, the controller (205) may be attached to the shelf unit behind or beside the C-channel (205) region to allow full use of the C-channel (205) for the graphical display device (105).

It will be appreciated that the system described provides great flexibility in the data presented to a customer or other user at the shelf where a product is stored. This data can include pricing, product identification, advertising, etc. typical components of a product label (210) displayed include the price, UPC, and stock keeping unit number (SKU). However, there is no limitation on the data displayed. The graphical display devices (105) may display information such as details about the product or its manufacturer including, but not limited to, trademarks, logos, name brands, product names, slogans, indicator of sales, discounts, clearances and the like. Consequently, a retailer or other vendor may also use the capability of the graphical display device (105) to increase sales or showcase new items. Using these displayed details, the customer or other user may more easily search for a specific product or brand, and the manufacturer and/or vendor can better market their product on the sales floor.

In many embodiments, it is desirable to have a method of automatically and uniquely identifying each graphical display device (105) to the central computing system (110). The unique identification of the graphical display device may be achieved in numerous ways: through a data identifier assigned to the electronic transmitter (such as an IP address) or through a manually-configured signature achieved by an array of toggle switches or a by durable mechanical encoding described below. For example, if each graphical display device (105) can identify its location within the storage space to the central computing system (110), the central computing system (110) can then immediately implement a desired inventory layout by sending appropriate display data to each of the graphical display devices (105). The identification of the location of the graphical display device could be accomplished either passively by linking the unique identifier with a database containing the physical location of the graphical display device, or actively by locating the transmitter by electronic sensing of time delays, triangulation or other remote sensing methods.

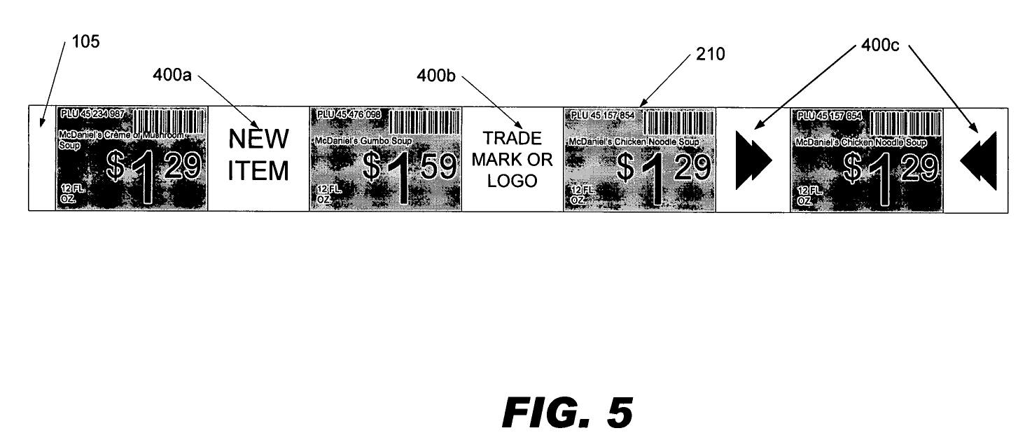

FIGS. 4a and 4b illustrate an embodiment in which the graphical display device or a component associated with the graphical display device senses or reads an identifier of a physical location within the storage space where the graphical display device is installed. The physical location of that display device, along with an identification of the display device itself, can then be transmitted automatically to the central computing system.

As shown in FIG. 4a, the graphical display device (105) includes a sensor set (225) that is formed at the end of a graphical display device (105). This sensor set (225) senses or reads an identifier of a physical location within the storage space disposed where the graphical display device is installed. In some embodiments, the sensor set (225) contains individual elements that are selectively actuated or formed when the graphical display device (105) is installed in the storage space to uniquely identify the location within the storage space where the graphical display device (105) is installed. The output of the sensor set (225) is read by an electronic reading device (230) and communicated to the electronic controller (205).

For example, the sensor set (225) can be an array of switches that are selectively actuated by physical, magnetic, electrical or optical means. When the graphical display device (105) is installed, each shelf channel or other installation location (227, FIG. 4b) in the storage space has a corresponding section with a unique pattern (226, FIG. 4b) of contacts, for example, raised bumps (as in Braille), optical elements, electrical or magnetic contacts, etc., that actuate a corresponding pattern of the switches (225) in the array of the graphical display device (105).

The graphical display device (105) then communicates the pattern of switches activated to the central computing system (110, FIG. 1). The central computing system can then identify the shelf or other storage location (227) within the storage space where the graphical display device (105) has been installed. The central computing system (110) has stored thereon a map that indicates which shelf, shelf segment or other storage location (227) within the storage space is associated with each pattern of activated switches based on the corresponding pattern of contacts (226) formed at that physical location (227) within the storage space.

In addition to signaling the location where it has been installed, the graphical display device (105) may also identify itself, such as with a serial or product number, name, address, etc., such that the central computing system can associate that graphical display device (105) with the physical location (227) within the storage space where it has been installed. The central computing system (110, FIG. 1) can then control that graphical display device (105) according to the product that should be stored at the corresponding location (227) within the storage space based, for example, on an inventory layout (101, FIG. 1).

In some embodiments, the pattern of contacts (226) that interact with the array of switches (225) in the graphical display device (105) are formed on a clip that is used to secure the display device (105) to a particular location (227). The pattern of contacts on that clip is formed to represent that location (227), where the clip stays even if the display device (105) is replaced. The mechanical clip can then be used to both pull the display device (105) into an installation channel or screw or lock the display device (105) in place while also identifying that location to the display device (105) and, ultimately, the central computing system (110, FIG. 1). In other embodiments, the pattern of contacts (226) may be formed on an adhesive label that is installed at each storage location (227).

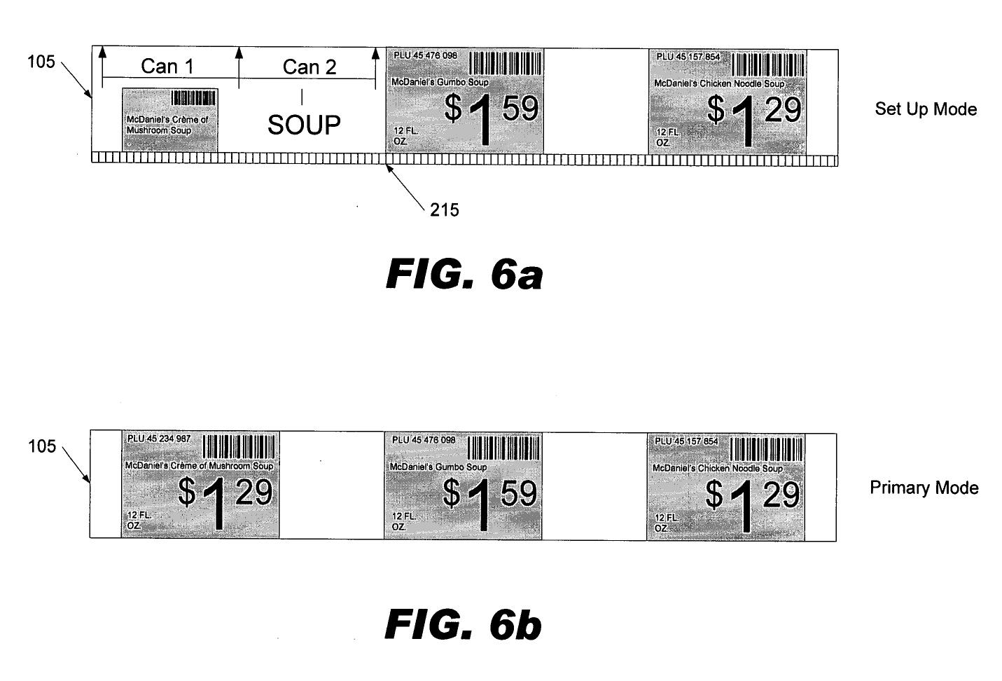

Some of possible uses of the graphical display device (105) will now be described and illustrated in FIG. 5. As shown in FIG. 5, graphical display device (105) has disposed along its length a series of exemplary product labels (210). Between these product labels (210) is additional display space that can be used to display auxiliary graphics (400a-c).

Auxiliary graphic (400a) is an example of a vendor's use of the graphical display device (105) to distinguish a particular product as being new, either as a recent product release or the first time the vendor has carried this particular product. Therefore, auxiliary graphic (400a) can be used to attract the attention of the customer and generate interest in a new product.

Auxiliary graphic (400b) displays a manufacturer's trademark or logo or a product name. This auxiliary graphic (400b) can be device which helps the customer recognize a particular brand or product.

The last auxiliary graphic (400c) is an exemplary use of directional symbols to help locate a specific product as per the request of a customer, employee or other user, which will be discussed in greater detail below. As shown in FIG. 5, this auxiliary graphic (400c) may include arrows that direct attention to a particular product label (210). In some embodiments, the arrows (400c) may flash to better draw attention to the indicated product label (210), depending on the nature and capabilities of the display technology employed as the graphical display device (105).

Each auxiliary graphic (400a-c) is imported from the central computing system (110, FIG. 1) and set by the electronic controller (205, FIG. 2). Using a system of integrated logic and hardware, the electronic controller (205) is able to control the graphics displayed on the graphical display device (105), communicate information and control power consumption. In addition to the graphics that are intended for the customer, i.e., the product labels (210) and auxiliary graphics (400a-c), the controller can also display the encoder strip (215) on the graphical display device (105), which will be described further below. The encoder strip (215) may include or encode a series of numbers, letters or symbols, e.g., a binary code.

One of the many advantages provided by the present exemplary embodiment is the ability of the ELS (100, FIG. 1) to respond to an inventory layout or a change to an inventory layout that is uploaded to the central computing system (110). In previous shelf labeling systems, the manual distribution or redistribution of shelf-edge labels and inventory can be a time consuming process. The present exemplary ELS (100) reduces inventory redistribution time by including a feature in conjunction with the graphical display devices (105), e.g., the encoder strip (215), that allows shelf space to be mapped out and then referenced in connection with an inventory layout.

Thus, because of the dynamic nature of the display devices (105), the owner or operator of the storage space or facility can constantly update or change as desired the labeling on the shelf space of the storage facility. For example, if products are remove from inventory or introduced into the inventory, the labeling on the display devices (105) can be automatically updated to reflect or even to help implement the change. In another example, if a product manufacturer adjusts the size of the product, to be either larger or smaller, the amount of shelf space allocated to that product will change accordingly. When something like this occurs, the output to the graphical display devices can be changed to spread out the labeling for a now-larger product or contract the labeling for a now-smaller product.

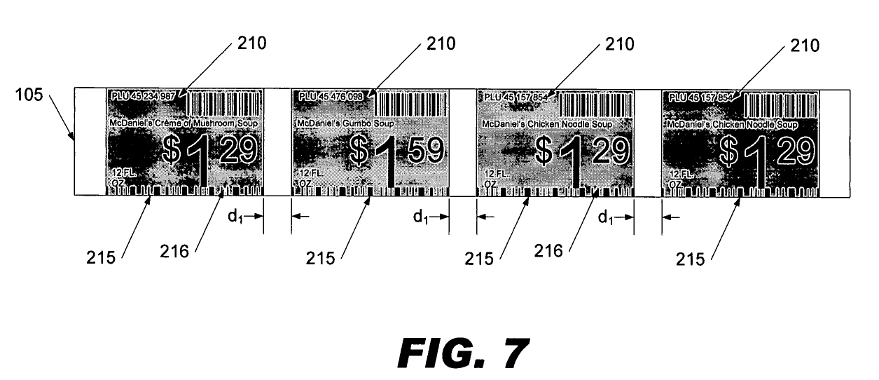

FIG. 6a depicts an exemplary graphical display device (105) displaying an encoder strip (215). The encoder strip (215) is machine-readable section of the graphical display device (105), e.g., a barcode. The encoder strip (215) can be printed on, or along the edge of, the graphical display device (105) or can be an element that is displayed by the graphical display device (105). As seen in the figure, the encoder strip (215) runs along the bottom edge of the graphical display device (105), but it may alternatively be placed elsewhere. In some embodiments, the encoder strip (215) may be configured to run the length of the graphical display device (105). In FIG. 6a, the encoder strip (215) is depicted as running along the length of graphical display device (105). However, this merely represents that the encoder strip (105) can be placed anywhere within that region. Consequently, in some embodiments, the encoder strip (215) is placed at predetermined intervals along the length of the graphical display device (105). Additionally, the encoder strip (215) can be configured to be visible during specific operating modes of the graphical display device (105) without being visible in other operating modes. The encoder strip (215) may be a linear data structure, like a UPC, or two dimensional, like a datamatrix.

As will be explained herein, the encoder strip (215) is used to create a storage space map with which the central computing system (110, FIG. 1) correlates specific locations in the storage space, e.g., specific shelf spaces, with particular graphical display devices (105) or portions of each graphical display device (105). Consequently, the encoder strip (215) may be present or visible when such a mapping operation is being conducted and may not be present or visible otherwise.

In many systems, it is desirable to have different modes of operation to facilitate specific tasks. In some cases modes of operation could be divided between a primary and secondary mode. In the present case, the primary operating mode may be a mode in which the graphical display device (105) displays information intended for the customer and does not display information not intended for the customer. In such a mode, information or graphics such as the encoder strip (215) could be hidden from view, because they generally have no direct value to the customer. FIG. 6b is an exemplary illustration of what graphical display device (105) might look like in such a primary mode.

Alternatively, information and graphics that are useful specifically for staff or employees of the storage space can be displayed when a secondary mode is toggled. An example of this mode is illustrated in FIG. 6a which includes, for example, the encoder strip (215). In the present example, this mode may be known as the set up mode. The set up mode is a secondary mode that can be used, for example, when resetting or changing the inventory layouts, assigning shelf space to inventory, or simply creating an storage space or inventory map. Therefore, the set up mode can be used by an employee or staff member of the storage space when changes are to be made to the displayed graphics and/or the inventory layout.

Any instructions that would be helpful to an employee or staff member can be displayed on the graphical display devices (105). For example, as shown in FIG. 6a, the set up mode may include instructions that show employees or staff members how to stock a particular shelf. In the example of FIG. 6a, when in a secondary or set up mode, the graphical display device (105) indicates a product, e.g. “SOUP,” that is to be shelved at a particular location and further indicates where and how may rows of the product to shelf, e.g., “Can 1” and “Can 2.” Thus, the electronic labeling system can be very helpful in conveying the intended inventory layout to the workers in the storage space who are to load the shelves with inventory accordingly.

Depending on the size of the encoder strip (215), the ELS (100) may be configured to display the encoder strip (215) or other set up mode elements during any mode, including a primary mode, as suits a particular application. If the encoder strip (215) or other set up mode elements are too large to be displayed without adversely affecting the display area used for customer information, or the operator of the facility prefers to hide the set up mode elements when the facility is being used by customers, then the ELS (100) can be configured to display the encoder strip (215) and/or other set up mode elements in a set up mode.

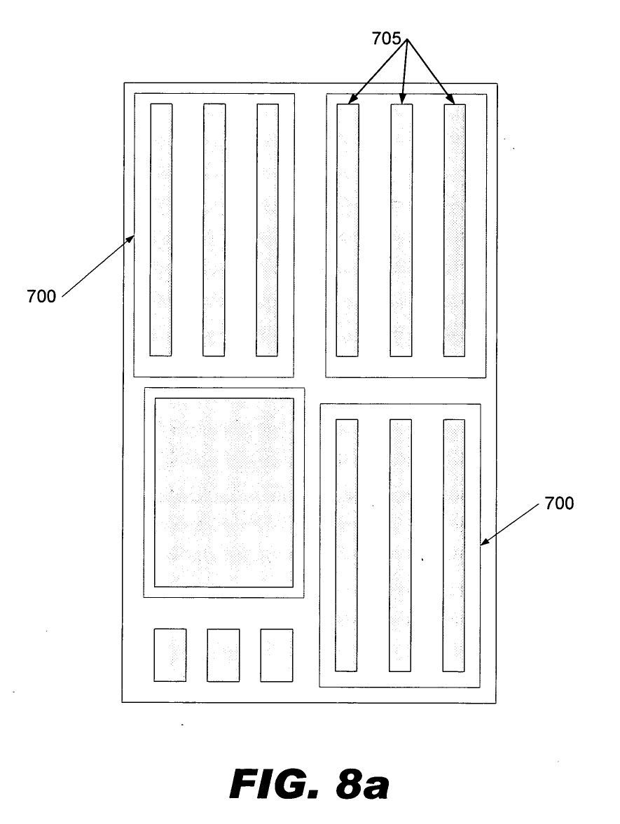

FIG. 7 demonstrates the placement of barcodes (216) along the encoder strip (215) that correspond to the length of shelf spaced allotted for a particular product. As shown in FIG. 7, placement of the barcodes (216) can reflect the density of product placement on a given self. In FIG. 7, an exemplary graphical display device (105) for a high density shelf is depicted. High density shelving can be described as shelving having many small products in close proximity each using a product label (210). A shelf containing bottles of spices could be an example of high density shelving. Accordingly, the graphical display device (105) has product labels (210) which are separated by a distance d₁. In cases of high density, the product labels (210) could also be modified to use less display area on graphical display device (105). However, the minimum limit on the length of the barcodes (216) of the encoder strip (215) may be determined by the minimum space used for each encoded barcode to be machine readable by the scanning device (120, FIG. 1). In some examples, on shelves classified for high density placement, spacing of ¼ inch between each encoder strip (215) may be adequate. On shelves classified as medium to low density, placement spacing of ½ inch may be adequate.

As will now be explained, the code contained by the encoder strip (215) is sent to the central computing system (110, FIG. 1) to create a map of the graphical display devices (105) as physically distributed throughout a storage space. This may be one method of mapping the storage space when the various storage locations within the storage space are without some means for allowing a graphical display device to automatically identify the location where it is installed and communicate that location to a central computing system as described above in connection with FIG. 4.

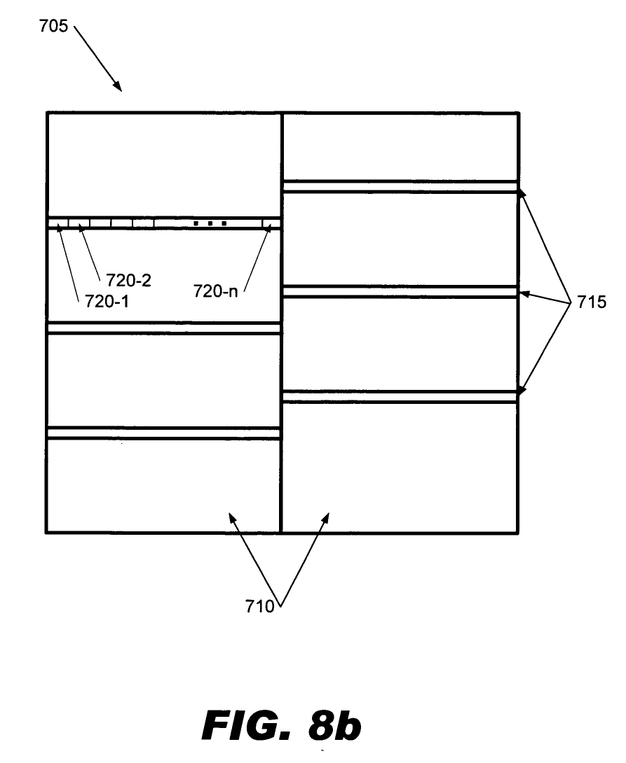

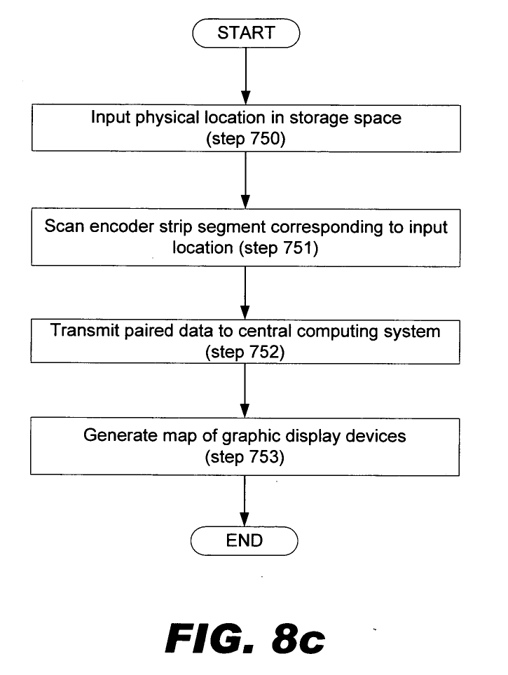

Referring to FIGS. 8a and 8b, a position within a storage space could be specified, for example by, region (700), aisle (705), set of shelves (710), shelf (715), and a segment of that shelf (720-1, -2 . . .-x). An exemplary illustration of a floor layout divided according this example is depicted in FIG. 8a. An exemplary illustration of a shelf set divided into shelf segments according to this example is depicted in FIG. 8b.

In the illustrated example, each graphical display device (105) corresponds to a specific segment or segments of shelf space (720), indicating that product labels (210) and/or auxiliary graphics (400) can be displayed at any of these positions on this graphical display device (105) for products that are to be placed on those corresponding shelf segments. Referring to FIG. 8c, using a scanning device (120), an employee or staff member of the storage space can input into the scanning device (120) an identification of a particular position within the storage space (step 750), e.g., an aisle, set of shelves, shelf and segment of shelf. This can be done using the user input device (122) of the scanning device (120). In some embodiments, the input is echoed on a data output device (123) of the scanning device (120).

The employee or staff member then scans (step 751) an encoder strip (215) or portion of encoder strip (215) that corresponds to the identified location within the storage space. This associates a physical location in the storage space with a particular portion of the graphical display device (105), as identified by a corresponding portion of encoder strip (215). The scanning device (120) then sends (step 752) this paired information to the central computing system (110). The central computing system (110) uses this information to build a map (step 753) of the storage space in which each defined location within the storage space is associated with the address of a graphical display device (105) or a portion of a graphical display device (105). Using this map, the central computing system (110) can address any graphical display device (105) or portion of a graphical display device (105) to display data for a corresponding specific shelf space.

The central computing unit (110) can then reference an inventory layout that describes which products are to be located at which locations within the storage space. Electronic labels associated with each such product can then be displayed by the graphical display device (105) at the corresponding physical location in the storage space based on the map that associates physical locations within the storage space with a particular graphical display device (105) or a portion of a graphical display device (105).

Additionally, the scanning device (120) can be used to effect changes to the display of the graphical display devices (105) by relaying commands to the central computing system (110). For example, the employee or staff member can input a desired change to a label (210) into the scanning device (120) using the user input device (122). The employee or staff member then scans the encoder strip (215) portion associated with the label to be changed or otherwise indicates the label that is to be changed, e.g., by entering the physical location of the label into the scanning device (120). This instruction is then transmitted by the scanning device (120) to the central computing system (110). The central computing system (110) then makes the corresponding change to the electronic label by transmitting the new display data to the corresponding graphical display device (105).

One advantage of the present exemplary system is the ability of the ELS (100) to upload and set inventory layouts automatically via the central computing system (110). In some examples, central computing system (110) will access a master or corporate computer system via known methods such as internet communication, cable, dial-up, satellite link, and the like. Once connected to the master server, information useful to the operation of the storage space can be downloaded, for example, pricing updates, inventory layouts, and advertisement graphics. The central computing system (110) can be configured to then reset or update all the graphical display devices (105) in the storage space that display product labels that are affected by information obtained from the corporate or master server.

Additionally, the described system can be used to identify and direct a customer or other user to a specific product. An auxiliary label (400, FIG. 5) that functions as a directional label (400c, FIG. 5) has been discussed above. In one embodiment, the ELS (100) is configured to use the auxiliary label (400) to help direct a user to a certain product. Additionally, when manually updating an inventory layout, it is often challenging to determine which products stay on the shelf, which are removed and which ones are displaced. The complexity of knowing what to move and not to move generally impels users, usually employees, to completely remove all stock from the shelves, then replace inventory according to shelf-edge labels. The present system can alleviate such tasks, by electronically changing all the tags and further flagging any changes in layout with auxiliary labels (400) which would visually indicate all changes in placement of product that are to be made.

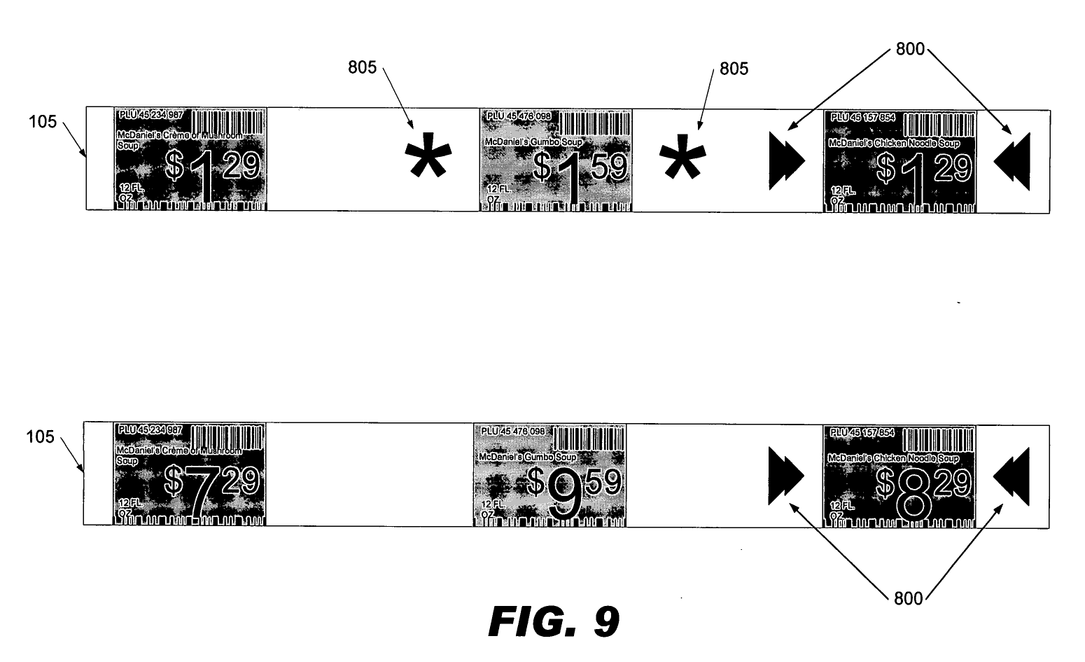

FIG. 9 illustrates the use of auxiliary labels (400) in inventory layout procedures. In some embodiments, after updating an inventory layout, the central computing system (100) compares the new inventory layout with the previous layout and records any changes in product location. The central computing system (100) uses this information to indicate the position of those changes by using the storage space map to properly place an auxiliary label (400). A change in position would indicate that the product is still to be shelved but in a different position on the shelf. A change in product would indicate that a new product that had not been previously displayed on the shelf is taking the place of the previous product. The exemplary system can accordingly attach different auxiliary labels (400) to visually indicate such changes to a shelf stocker. For example, with reference to FIG. 9, a change in position could be referenced by a set of flashing arrows (800), while a change in product could be indicated by flashing asterisks (805). This is advantageous because it allows the employee to easily observe and focus on products that are to be moved or replaced, without having to remove the entire inventory from the shelves.

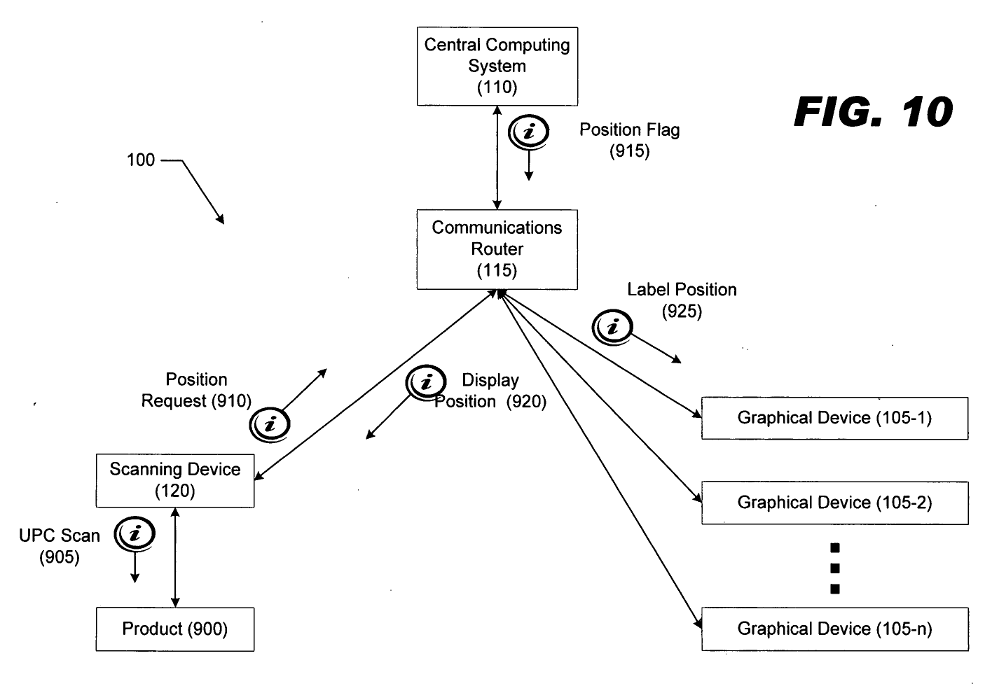

FIG. 10 is an illustration of an exemplary position request using the present system. The ability of the ELS (100) to visually indicate the location of any given product found on the shelves is beneficial in setting inventory layouts and in helping both employees and customers find desired products. For example, during the course of the day, a vendor typically receives many returned items, and un-purchased items at a customer service desk. Daily restocking of such items is done by the employees. Such restocking often uses a high level of familiarity with the floor plan of the entire storage space or facility because most items are generally found in one unique position.

The present exemplary ELS (100) enables all employees, from the newest hire to the longest tenured, to be able to easily locate any item in a store. For example, in some embodiments, the employee can scan the UPC on an item to be shelved or re-shelved (900) using the scanning device (120). The scanning device (120) transmits an identification of the product based on the scanned UPC and makes a position request (905) to the central computing system (110). The central computing system (110) uses the inventory layout (101, FIG. 1) to identify whether the identified product is stored within the storage space. The central computing system (110) can be configured to relay the requested positional information for the identified product to both the scanning device (120) and the corresponding graphical display device (105). Consequently, the location of the item in the storage space can be displayed on the data output device (123, FIG. 1) of the scanning device (120).

In the case where the identified product is stored at multiple positions within the storage space, the central computing system (110) may be configured to identify all such product locations or the product location closest to the scanning device without identifying other product locations. The location of the scanning device (120) can be sent to the central computing system (110) at any time by simply scanning an encoder strip at the location of the scanning device (120). The central computing system (110) can then determine which location where the identified product is stored is closest to the location of the scanning device (120).

Using the provided information the user can now locate the right aisle, shelf unit and shelf for the product. The ELS (100) may alternatively or additionally be configured to operate lighting, signage or other visual indicators in the storage space to indicate a product location. For example, lights or other visual indicators could direct the user to the correct aisle and/or shelf unit. Once the correct aisle and/or shelf unit has been located, the system could also use the graphical display devices (105) to indicate the exact position on the shelving of the desired product as shown, for example, in FIG. 5, by the displayed arrows (400c).

To assist users in the storage space, such as customers, who may not have the use of a portable scanning device, stationary scanning devices can be placed at strategic locations in the storage space. Such a stationary scanning device may be functionally identical to the portable scanning device (120, FIG. 1) described above. These stationary scanners could be used by customers in situations where they have found a product with no price, or that is out of place, for which they wish additional information. The product can be scanned using the stationary scanning device and information about the product returned to a display device on the scanner by the central computing system.

In other cases, the customer could bring in an old container or UPC of the product they are seeking. The product identifier is scanned with the stationary scanner which contacts the central computing system for product location. Then, as described above, the production location can be displayed for the user on the stationary scanner. Additionally or alternatively, an auxiliary display on a graphical display device (105) can indicate the exact location of the desired product, with or without further visual indicators to direct the user to the correct shelf unit.

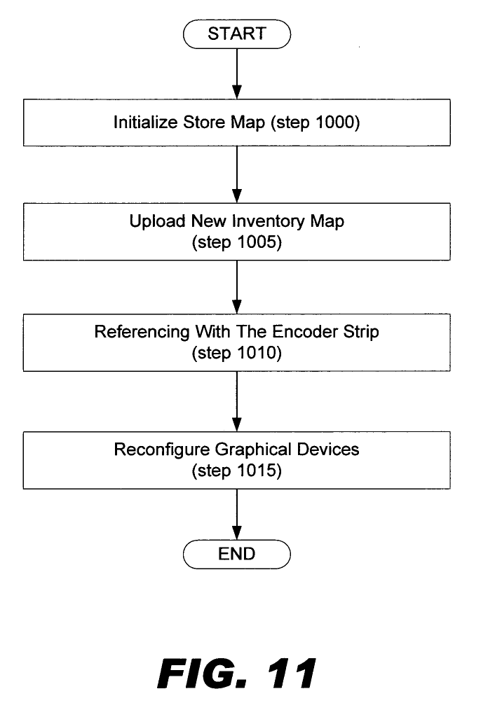

FIG. 11 illustrates an exemplary method of setting an inventory layout using the present system and method. Initially or occasionally, a new inventory layout (101, FIG. 1) will be implemented. If a previous inventory layout has existed, it will be replaced. One way an inventory layout could be reset is by disassociating all products from mapped positions, uploading a new inventory layout that references particular products with specific locations in the storage space and then re-configuring the graphical display devices (105) to display corresponding labels for products based on the new inventory layout.

Disassociating products from the existing map could entail initializing the data structure containing the store map, where no products are then associated with a position(s) of shelf space. Once the map has been initialized, the central computing system (110) could use the new inventory layout to associate a UPC or SKU, i.e., a product, with each position on the shelves of the storage space. As noted above, the position on the shelf as it corresponds to a graphical display device (105) is identified by the encoder strip (215). Once all references have been made, the central computing system (110) instructs the graphical display devices (105) to display the desired graphics for corresponding products. Each graphical display device (215) places the graphics in the correct position as indicated by the encoder strip (215). Using the map of graphical display devices (105), the central computing system (110) is therefore able to make the appropriate changes to the product labels (210) and the auxiliary labels. In the case where the inventory layout has been rearranged, an employee or staff member can then go to the area of the store that has been updated, and manually move the inventory as appropriate to correspond to the newly-displayed product labels. No manual changes of label placement would typically be performed. In this way, the present exemplary system helps reduce the amount of worker hours used to reset an inventory.

An example of this process is illustrated in FIG. 11. As shown in FIG. 11, an inventory layout is set by initializing the store map (step 1000), uploading a new inventory layout (step 1005), referencing the products with locations in the storage space as identified using the encoder strip (step 1010) and re-configuring graphical display devices (step 1015).

Initializing the data structure containing the store map (step 1000) is done by the central computing system (110) which accesses the current store map. In one embodiment, an archive file may be used to save in memory the current store map before updating. In this way the central computing system (110) could use archived store maps to identify changes between the archived and new store maps. Next the data structure used to implement the map could be initialized. In this state the store map has every position in the store reference by the encoder strip (215) but no UPC or SKUs, i.e., products, are associated with a position(s) of shelf space.

After initialization (step 1000) the central computing system (110) uploads a new inventory layout (step 1005). New inventory layouts are generally received from a corporate office, but in some cases may be done internally for smaller retailers. In the present system inventory layouts are electronic files that may or may not include an executable to update the store map. The new inventory layout is used to associate a UPC or SKU, i.e., a product, to a position on the shelf.

As stated before, the position on the shelf is referenced by the encoder strip (step 1010). In this step the central computing system (110) will link each UPC in the inventory layout to a position within the store. This position is electronically addressed within the data structure of the store map. As described before, the encoder strip (215) can visually be identified on the graphical display device (105), and the encoding barcode that is seen will reference the correct electronic address of the store map.

Once all references have been made, the central computing system (110) instructs the graphical display devices (105) to display the desired graphics (step 1015). Each graphical display device (215) places the graphics in the correct position as indicated in the encoder strip (215). Using the map of graphical display devices (105), the central computing system (110) is therefore able to make all appropriate changes to the product labels (210) and the auxiliary labels (400). In the case where inventory layout has been rearranged, an employee could then go the area of the store that has been updated, and manually move the inventory as appropriate. No manual changes of label placement would typically be performed. In this way the present exemplary system helps reduce the amount of man hours used to reset an inventory.

In conclusion, the present exemplary systems and methods provide for the creation and operation of an inventory locator and electronic labeling system. In particular, according to one exemplary embodiment, an electronic labeling system can be configured to upload an inventory layout and project this layout via graphical display devices for correct placement of inventory without the displacement of the labels. Additionally, this exemplary embodiment can also assist staff, and customers in locating a particular item in the inventory via visual indicators incorporated within the graphical display device.

The preceding description has been presented to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. A labeling system comprising:
at least one display device associated with one or more particular locations within a space; and
a device associated with said at least one display device that identifies that display device or a portion thereof with a particular location in said space.

2. The system of claim 1, wherein said device comprises an encoder strip.

3. The system of claim 2, wherein said encoder strip is displayed by said display device.

4. The system of claim 3, wherein said encoder strip is displayed during a particular operating mode of said system.

5. The system of claim 1, further comprising a scanning unit for reading said device and transmitting to a central computing system an association of a display device or a portion thereof with said particular location in said space based on reading said device.

6. The system of claim 1, wherein said at least one display device comprises a graphical display device that displays product information related to a product stored at a corresponding location within said space.

7. The system of claim 6, wherein said display device further displays indicators adjacent to said product information to locate or highlight particular product information.

8. The system of claim 1, wherein said device comprises a sensor set of said display device that senses an identifier of said particular location.

9. The system of claim 8, wherein said sensor set comprises an array of switches and said identifier comprises a pattern of actuators for actuating some of said switches in said pattern that uniquely identifies said particular location within said space.

10. A method of operating a labeling system that includes display devices distributed throughout a space, said method comprising:
identifying a physical product location in said space; and
identifying a display device or a portion thereof that is associated with said product location.

11. The method of claim 10, further comprising:
transmitting said identification of a physical product location and a display device or portion thereof associated with that product location as paired data to a central computing device; and
preparing a map correlating each product location in said space with a display device or portion thereof.

12. The method of claim 11, further comprising obtaining an inventory layout that correlates each product location in said space with a product to be stored at that location.

13. The method of claim 12, further comprising using said map to display information regarding each product to be stored in said space using a display device or portion thereof at a product location where that product is to be stored.

14. The method of claim 13, further comprising implementing a new inventory layout by using said map to display information regarding each product to be stored in said space using a display device or portion thereof at a product location where that product is to be stored according to said new inventory layout.

15. The method of claim 10, further comprising identifying said product location with an identifier disposed at said product location and readable by a sensor set of said display device when said display device is installed at said product location.

16. A method of operating an electronic labeling system that includes display devices distributed throughout a space, said method comprising:
preparing a map correlating each of a plurality of product locations in said space with a display device or portion thereof; and
implementing a new inventory layout by using said map to display information regarding each product to be stored in said space using a display device or portion thereof at a product location where that product is to be stored according to said new inventory layout.

17. The method of claim 16, further comprising displaying an indicator on said display devices at any product location where the product to be stored at that location has changed according to said new inventory layout.

18. The method of claim 16, further comprising displaying instructions to a worker that indicate a location and number of rows for product to be placed.

19. The method of claim 16, wherein said new inventory layout includes a change in space allocated to a particular product, said method further comprising automatically adjusting display of labeling for that product on said display devices to account for said change in space allocated.

20. The method of claim 16, wherein said preparing a map is performed by sensing identifiers that are each disposed at a particular location within said space and that uniquely identify those respective locations, wherein said method comprises sensing each said identifier with a display device installed at a location of said identifier and transmitting an identification of that location based on said identifier and an identification of the corresponding display device to a central computing system.

21. The method of claim 16, wherein said preparing a map is performed by identifying a location with said space of each of said display devices electronically based on wireless transmissions received from each said display device.

22. A method of operating an electronic labeling system that includes display devices distributed throughout a space, said method comprising:
scanning a product identifier and transmitting that identifier to a central computing system;
identifying a location in said space where a product corresponding to said product identifier is stored; and
indicating said location to a user.

23. The method of claim 22, wherein indicating said location comprises transmitting an identification of said location back to a scanning unit with which said user performed said scanning.

24. The method of claim 22, wherein indicating said location comprises operating a system of visual indicators within said space to direct said user to said location.

25. The method of claim 24, wherein said operating a system of visual indicators further comprising operating lighting or other visual indicator to indicate a particular area of said space containing said location.

26. The method of claim 25, further comprising displaying an indicator with a display device associated with said location.

27. The method of claim 22, wherein indicating said location to said user further comprising displaying an indicator with a display device associated with said location.
